(19) United States
(12) Patent Application Publication
(10) Pub. No.: US 2011/0313734 A1
(43) Pub. Date: Dec. 22, 2011

(54) Model Assembly of a Production Plant With True-To-Scale Models of Production Devices and Method for Inputting a Spatial Assembly of Production Devices Into a Computer-Assisted Planning Program

(76) Inventors: Christian Grosch, Kraftisried (DE); Christian Rossmüller, Robbach (DE); Sanja Uzelac, Geiselbullach/Olching (DE); Christoph Von Essen, Munchen (DE)

(21) Appl. No.: 13/147,258

(22) PCT Filed: Jan. 20, 2010
(86) PCT No.: PCT/EP10/50604

§ 371 Date: Sep. 8, 2011

(30) Foreign Application Priority Data
Jan. 30, 2009 (DE) 10 2009 007 477.5

(51) Int. Cl. G06F 17/50

(52) U.S. Cl. 703/1

(57) ABSTRACT

In a method for factory planning and a model assembly (13) that is used to perform the method, the models (24, 25) of the model assembly are provided with information carriers (26) such as two-dimensional bar codes so that the position thereof can be determined by digital image processing after placement on the underlayment (14). Thus the real models (24, 25) can be used for concrete factory planning by a three-dimensional, real model, wherein it is possible to transfer the data arising in such a way into a planning program by the information carriers. Advantageously, the method of intuitive factory planning by real models and the method of factory planning by planning programs can be combined with each other in this way, wherein an efficient interface between both planning steps is created by the information carriers, wherein the interface enables in particular also interactive work with both planning methods.

### CROSS-REFERENCE TO RELATED APPLICATIONS

This application is a U.S. National Stage Application of International Application No. PCT/EP2010/050604 filed Jan. 20, 2010, which designates the United States of America, and claims priority to German Application No. 10 2009 007 477.5 filed Jan. 30, 2009 the contents of which are hereby incorporated by reference in their entirety.

### TECHNICAL FIELD

The invention relates to a model assembly of a production plant wherein this model assembly is composed of a planar base on which there is a multiplicity of real, two-dimensional or three-dimensional models of production devices, said models being true-to-scale at least with respect to their area requirement on the base. Furthermore, the invention relates to a method for inputting a spatial assembly of production devices, which together form a production plant into a computer-assisted planning program.

### BACKGROUND

A production plant is to be understood in the wider sense as a structure which is composed of at least two production devices, this can mean, for example, a production cell which contains a plurality of machines. However, a production plant can also be understood to be, for example, an entire factory hall or even an entire factory as a model. Production devices are to be understood in the wider sense as all spatial units which are necessary for production. These include, in the narrower sense, machines for processing products but at the same time devices for transporting the products between the different machines as well as further spatial devices which are necessary in the production plant. Such spatial devices can be understood as being, for example, offices for production managers, walkways for employees, etc.

It is generally known per se to represent production plants, such as for example factory halls, as a model. In particular in the planning phase, such models can assist the imagination of those involved in the planning.

An alternative which suggests itself are computer-assisted planning tools for planning factories, such as are offered, for example, under the commercial name GLOVIA by Fujitsu in a company brochure of 2008. These computer-assisted planning tools require virtual three-dimensional models of the production devices and of the spatial conditions of the production plant to be input. The models which are generated in this way can then be assembled in a virtual environment and a production sequence can be simulated in order to make it possible to draw conclusions about the functional capability of the planned production plant.

Optimization processes, which permit the production sequences, the demand for space and further aspects to be optimized before assembly of the production plant can be carried out both by means of real model assemblies and by means of computer-assisted simulations of production plants. In this context, real model assemblies have the advantage that there is an intuitive interface for the factory planner. On the other hand, computer-assisted planning programs have the advantage that it is easier to simulate the production sequence and further data, in addition to spatial data, can also be processed during the formation of the model.

In order to be able to assemble a simulation of the production plant in the planning program described above, it is necessary, in fact, for the peripheral conditions for the respective application case which is to be planned to be known. These include the spatial conditions of the production plant which can already be present (optimization task) or still have to be established (planning task) and the properties of the production devices which are being applied. The data can already be present in databases, with the result that linking to the planning program can be carried out comparatively easily. However, data which are not yet available have to be input into the planning program, which involves effort by the planner of the factory.

In order to facilitate the effort involved in inputting the data into the planning system, US 2002/0107674 A1 proposes that the models of the production devices can be provided, for example, with two-dimensional markers which are suitable for the recognition of the individual models. By using these markers it is possible, for example by means of an optical recognition system to recognize the identity of the individual production devices. Furthermore, it is possible to recognize the orientation of said production devices. The model itself can also be used as a marker by means of a relatively large amount of computational effort, in which case said model has to be recognized by suitable optical recognition methods.

### SUMMARY

According to various embodiments, on the one hand, a real model assembly of a production plant with models of the production devices can be specified and, on the other hand, a method for inputting the interaction between production devices of a production plant into a computer-assisted planning program can be specified, wherein the model assembly and the inputting method are to be comparatively efficient to use.

According to an embodiment, a model assembly of a production plant may be composed of a planar base and a multiplicity of real, two-dimensional or three-dimensional models of production devices, said models being located on said base and being true-to-scale at least in terms of their area requirement on the base, and the models being provided with machine-readable carriers of identification codes, wherein the carriers have, in addition to the identification codes, position codes which contain coordinates of the respective position of the carriers on the models.

According to a further embodiment, the carriers can be read out optically and are accessible optically from a viewing direction from above onto the base. According to a further embodiment, the identification codes can be composed of one-dimensional or two-dimensional barcodes.

According to another embodiment, in a method for inputting a spatial assembly of production devices, which together form a production plant, into a computer-assisted planning program, real, two-dimensional or three-dimensional models, which are true-to-scale at least in terms of their area requirement, of the production plants are generated, the models are provided with machine-readable carriers of identification codes, in addition to the identification codes, position codes are provided on the carriers, which position codes contain the coordinates of the respective position of the carriers on the models or which supplement the data records of the production devices in the planning program with the coordinates of the respective position of the carriers on the models, a model assembly of the production facility is formed on a planar base using the models, at least one digital image is created of the model assembly with an image sensor from a viewing direction from above onto the base, the identification codes of the models are registered by machine, the position of the models represented by the carriers on the base is calculated by determining the position of the carriers taking into account the position codes of the carriers or the coordinates of the position in the data records of the planning program, the positions of the models are linked to data records of the production devices in the planning program by means of the identification codes.

According to a further embodiment of the method, the carriers can be read out optically and are mounted on the models in such a way that they are optically accessible from a viewing direction from above onto the base after the models have been placed on the base. According to a further embodiment of the method, the digital image can be evaluated for the purpose of the machine registration of the optically readable identification code. According to a further embodiment of the method, a plurality of overlapping images of the model assembly can be recorded. According to a further embodiment of the method, the images may overlap to such an extent that each carrier is depicted on at least two images, and faults during the determination of the position of the respective model owing to the perspective distortion in the images are corrected by comparing at least two relevant images. According to a further embodiment of the method, a chronological sequence of digital images can be created of the model assembly using the image sensor, changes in the positions of the carriers are determined by comparing the images, and the updated positions of the carriers are linked to data records of the production devices in the planning program by means of the identification codes. According to a further embodiment of the method, with the planning program an output device can be actuated, on which the changes in the positions of the production devices which are linked to the carriers are represented.

### BRIEF DESCRIPTION OF THE DRAWINGS

Further details of the invention are described below with reference to the drawing. Identical or corresponding elements in the drawing are respectively provided with the same reference signs in the figures and are explained repeatedly only to the extent that differences arise between the individual figures. In the drawing:

FIG. 1 shows a schematic view of the application of an exemplary embodiment of the method in a space, and

FIG. 2 shows a spatial representation of a detail of an exemplary embodiment of the model assembly.

### DETAILED DESCRIPTION

According to various embodiments, the models are provided with machine-readable carriers of identification codes. Carriers of information are to be understood in the wider sense as all physical devices which can make machine-readable information available. This means that this carrier must be assigned in each case a possible way of reading by machine using a suitable reading device. For example, the carrier can store the information magnetically, in which case a magnetic sensor has to be provided as a reading device in the vicinity of said carrier in order to read this information. A further possibility is to use what are referred to as RFID tags which are activated by a suitable reading device and which emit information stored in the carrier, for example over a radio interface or infrared interface. Another possibility is to use acoustic information. For this purpose, the carrier has to emit an acoustic signal which can be picked up by an acoustic sensor.

According to various embodiments there is provision that the carrier has, in addition to the identification codes, position codes which contain coordinates of the respective position of the particular carrier on the particular model. By means of the identification code it is, in fact, only possible to identify the model by means of the carrier, with the result that data about the model are made available by the reading in and can be fed into the planning program. However, if the position of the model on the plan is also to be determined by means of the image, it is advantageous for this purpose to determine only the position of the information carrier. This is possible with comparatively little computational effort since it only has limited dimensions. If the position of the information carrier on the associated model is known, the position of the model on the base can also be inferred by means of the determined position of the information carrier. This advantageously permits simple modeling of a real model assembly in a planning program.

According to an embodiment, there is provision that the carriers can be read out optically and are accessible optically from a viewing direction from above onto the base. The optical accessibility is necessary since, in order to create the model assembly, the models are placed on the base. The base therefore forms a model of the floor of the production plant, wherein the configuration of the carrier by optical means can best take place, as it were, from a bird's eye perspective, without the models overlapping one another. In this context, a vertical viewing direction is particularly advantageous. Of course, viewing directions which deviate from this can also be selected as long as it is ensured that the models do not overlap one another. In particular when two-dimensional models are used, that is to say for example for small plates which merely represent the outlines of the production devices on the base, a comparatively large angle for the viewing direction of, for example 20° to 90° can be selected. If three-dimensional models are used, an angle for the viewing direction of 60° to 90° is advantageous. The vertical viewing angle corresponds to an angle of 90°.

In particular if a camera which contains an image sensor and a lens is used as the device for reading the carriers, it is also necessary to take into account the fact that a vertical viewing direction is ensured only in the center of the recorded image. At the edges of the image there are inevitably viewing directions from above onto the base which differ from the perpendicular with respect to the base.

According to another embodiment, there is provision that the identification codes are composed of one-dimensional or two-dimensional barcodes. This has the advantage that the barcodes can be readily evaluated within the scope of processing of the digital images of a camera. In this context, customary standards can be used for the barcodes, with the result that recognition can advantageously take place quickly and reliability with available software. Examples of a one-dimensional barcode can be code 39, code 93 or code 128. Representatives of two-dimensional barcodes are, for example, the UR code, the DATAMATRIX code or the AZTEC code.

Furthermore, according to other embodiments, the method referred to at the beginning may comprise the following method steps that are run through. Real, two-dimensional or three-dimensional models, which are true-to-scale at least in terms of their area requirement, of the production devices are generated. The models are provided with machine-readable carriers of identification codes. A model assembly of the production facility is formed on a planar base using the models. At least one digital image is created of this model assembly with an image sensor from a viewing direction from above onto the base. The identification codes of the models are registered by machine. The positions of the models which are associated with the carriers are determined in the digital image. Finally, the positions of the models are linked to data records of the production devices in the planning program by means of the identification codes. The terms which are used to describe the method have already been explained at the beginning within the scope of the explanation of the embodiments relating to the model assembly and have the same meaning with respect to the method embodiments.

According to various embodiments there is provision that, in addition to the identification codes, position codes are provided on the carriers, which position codes contain the coordinates of the respective position of the carriers on the models. It is then possible to calculate the position of the models, represented by the carriers, on the base by determining the position of the carriers while taking into account the position codes. In particular, the following procedure is adopted here. The position of the carrier is determined in the image. In this context, a plurality of images can possibly be evaluated in the described fashion in order to determine the position of the carrier without doubt. The position codes are then superimposed on the position of the carrier, with the result that the position of the entire model on the base can be inferred as a function of the position of the carrier. This inference is therefore made by means of a calculation of the planning program, to which program the information which is necessary for this purpose is made available in the form of identification codes and position codes.

An alternative possibility for the solution according to various embodiments is that the data records of the production devices in the planning program already contain the coordinates of the respective position of the carriers on the models. In this case, no position codes are necessary on the carriers since these data have already been stored in the planning program. Said data can be retrieved by evaluating the identification codes of the respective model and, after identification of the model, retrieving the coordinates of the position of the carrier from the data record of the production device. If said coordinates are available, the position of the models, represented by the carriers, on the base can be calculated by determining the position of the carriers while taking into account the position of the carriers on the models.

The idea according to various embodiments is that it is advantageously possible for the planner of a factory to use real models on a base to intuitively assemble planning variants of the planned production plant in an easy way. In this context it is also advantageously possible to use personnel who are not experienced in the use of program-assisted planning tools for planning a factory but rather can introduce valuable practical knowledge owing to their activity. Examples are employees from production such as production managers and skilled craftsmen. On the other hand it is advantageously not necessary to dispense with checking of the planning variants by means of planning programs. The inputting of the data into the planning program advantageously occurs in automated fashion here, with the result that the workload of a factory planner who is experienced in handling planning programs can be advantageously reduced. As a result, the use of the planning program is accelerated and therefore becomes more economical. Furthermore, solutions for the planning concept for the planning of a factory can be found in a more advantageous way overall within a relatively short time and furthermore the optimization potential of the employee involved in production can be advantageously increased in this context.

According to an embodiment there is provision that the carriers can be read out optically and are mounted on the models in such a way that they are optically accessible from a viewing direction from above onto the base after the models have been placed on the base. The sequence of the planning process in the planning phase with real models is carried out as follows. The models are placed on the base, as a result of which a model assembly of the production plant is produced. The latter is recorded by means of an optical sensor from above, i.e. preferably from a viewing direction perpendicular with respect to the base, possibly however also from a viewing angle which deviates from this perpendicular viewing direction. This results in digital images which can be subjected to further image processing. Since the carriers are advantageously optically accessible from above, they are also depicted on the digital image, with the result that the optical information can be evaluated by the image processing.

Furthermore, it is advantageous if a plurality of overlapping images of the model assembly are recorded. As a result it is possible to keep the viewing angle in the images small by using corresponding optics with relatively long focal lengths and to combine the plurality of images to form a single image by evaluating the overlaps. As a result, the models of the production devices can be placed in a relationship with one another on the various images.

It is particularly advantageous if the images overlap to such an extent that each carrier is depicted on at least two images. Faults during the determination of the position of the respective model owing to the perspective distortion in the images can be corrected by comparing at least two relevant images. Relevant images are those images which depict the respective carrier. This must be at least two images. The perspective distortion in relation to this device is to be understood as the fact that an image can only be recorded precisely from the predefined viewing direction, for example from the perpendicular viewing direction, in the optical axis of the lens. The object in the edge regions of the recorded image necessarily have a viewing direction which differs from this particular viewing direction and which has to be taken into account in the determination of the position of the respective carrier on the base. By comparing the position of the respective carrier on another image it is possible to determine this position error wherein in this context the distance between the image axes of the two images from one another is taken into account.

An embodiment of the method is obtained if a chronological sequence of digital images is created of the model assembly using the image sensor. This chronological sequence provides, as it were a film which represents the intuitive planning process through the adjustment of the models. The intervals between the creation of the individual images can be freely selected here, wherein the individual images are intended to permit a comparison between the different planning states. As a result, changes in the positions of the carriers can be determined by comparing the images. The updated positions of the carriers can then be linked to data records of the production devices in the planning program by means of the identification codes, and the virtual model of the production plant which is used in the planning program can be respectively adapted to the real model.

It is advantageously possible with the planning program to actuate an output device on which the changes in the position of the production devices which are linked to the carriers are represented. This has the advantage that during the intuitive planning phase using the real model it is already possible to determine which effects the proposed (adjusted) changes have on the virtual model of the production plant which is contained in the planning program. As a result, it is also possible to check statements which can be created only with the planning program. In this context, customary planning programs can be used. Classic CAD applications as well as further planning programs such as, for example, transport matrix/Sankey diagram representation, arrangement optimization according to Schmigalla or a useful value analysis, are also conceivable.

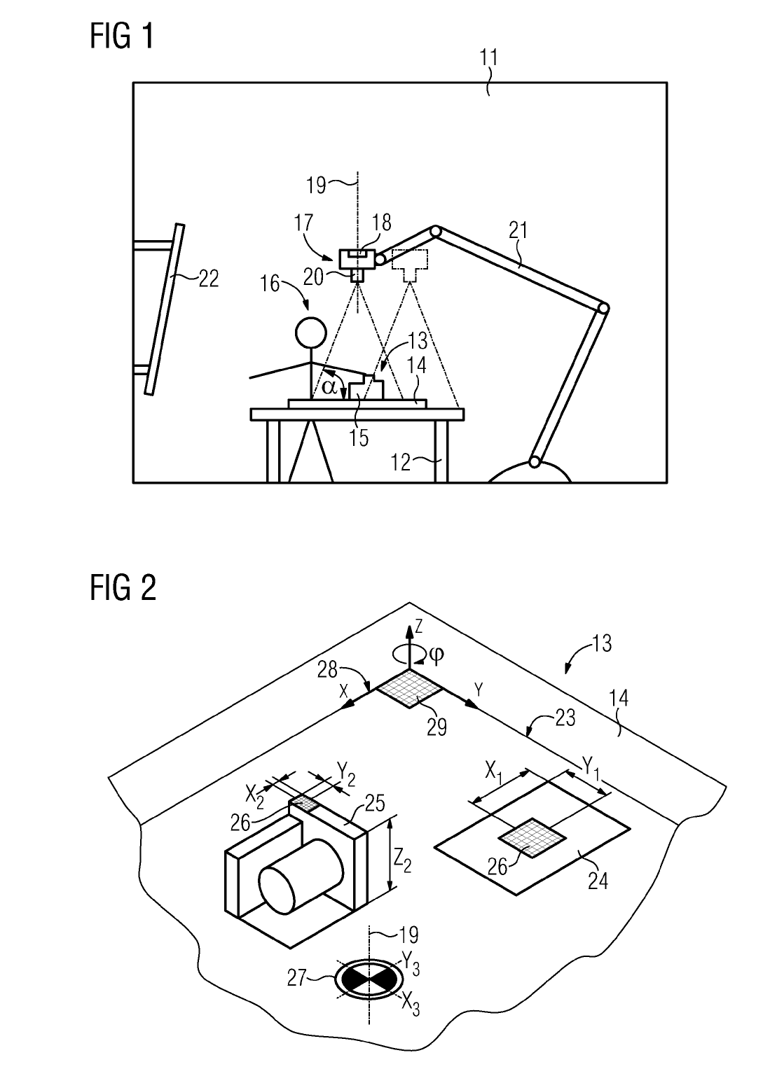

FIG. 1 illustrates a space 11 in which the planning method according to various embodiments is to be carried out. In the center of the space there is a table 12 on which a model assembly 13 is illustrated schematically. The latter is composed of a base 14 on which a model 15 of a machine is positioned in exemplary fashion as a production device. The base represents, in a fashion not illustrated, the outline of a production plant in the form of a factory hall.

A first significant method step in the planning method according to various embodiments is that a factory planner 16 manually positions the model 15 at its correct location. Further models (not illustrated) and further persons (likewise not illustrated) can be involved in this planning phase.

During this planning phase, a digital camera 17 takes recordings (images) of the model assembly 13 at regular time intervals by means of an image sensor 18. This is done from above, in the exemplary embodiment precisely in the perpendicular direction, i.e. following the force of gravity. As a result, an image axis 19 is produced which is perpendicular to the base 14. However, owing to the focal length of a lens 20 of the digital camera 17 a viewing direction α, which is at approximately 75° with respect to the base 14 is obtained for the models at the edge of the recorded image.

In order to be able to determine the position of the model precisely despite the perspective distortion owing to different viewing directions within the image, at least one further image is recorded using the digital camera 17 from the position which is represented by dash-dot lines. In order to move the camera, the latter is mounted on a stand 21. Alternatively, the camera can also be held by the factory planner and oriented manually (not illustrated), and in this case a stand is not necessary.

The image data of the digital camera 17 are processed in a second planning step by a planning program in a way which is not illustrated and are output in the space 11 by means of an output device 22 in the form of a screen which is located on the wall. As a result, interactive action on the model assembly 13 is possible for the factory planner 16, wherein modifications to the planning result which is represented by the model assembly 13 are displayed immediately on the output device 22, so that the results achieved intuitively on the model assembly 13 can be simultaneously subjected to analysis by the planning program. In this way, brief corrections are possible, as a result of which efficient optimization of the planning result can take place.

FIG. 2 illustrates a representative detail of the model assembly 13 according to FIG. 1. The outline 23 of the factory hall to be planned can be seen on the base 14. A two-dimensional model 24 and a three-dimensional model 25 of production devices can also be seen on the base. These may be, for example, machines or a production cell. Models 24, 25 are positioned at specific locations on the base and therefore represent a specific planning state in the process of the factory planning.

The models 24, 25 are provided with carriers 26 of information. In the exemplary embodiment according to FIG. 2, these are carriers of optical information in the form of a two-dimensional barcode. The information includes an identification code for the respective model, which has to be unambiguously assigned to a production device to be planned in this way and which is stored in the planning program. Furthermore the carriers contain information about their position on the respective model. In the exemplary embodiment according to FIG. 2, this position information is expressed, for example, by being represented in a Cartesian coordinate system x-y-z as in FIG. 2. Since the models on the base can also be rotated, there is also a coordinate φ which expresses the rotational angle, about the perpendicular z axis, of the relative coordinate systems (not illustrated), associated with the models, with respect to a positionally fixed coordinate system 28 of the base.

The model 24 is a two-dimensional model, with the result that in this case only one coordinate x₁ and one coordinate y₁ are stored. The model 25 is described as a three-dimensional model by the coordinates x₂, y₂, z₂.

In this context, the coordinates respectively indicate the position of the central point of the respective carrier 26 with respect to the rest of the model.

The angle coordinate φ cannot be stored on the carrier. It must instead be determined by taking into account the angular position of the model 24, 25 on the base. For this purpose, the carrier can have orientation information whose angular position is acquired by image processing of the recorded image.

Furthermore, on the base a mark 27 with the coordinates x₃, y₃ with respect to the positionally fixed coordinate system 28 is provided. This serves to orient the digital camera 17, with the result that the position of the image axis 19 with respect to the positionally fixed coordinate system 28 is known. This facilitates the spatial integration of the models in the planning program. Finally, a further carrier 29, which characterizes the position of the positionally fixed coordinate system 28 is provided on the base.

The position codes are only represented in an exemplary fashion and can also be represented in different ways. In particular, the indicated coordinates can also be input directly into the planning program, with the result that it is not necessary to carry out storage on the carriers. In this case, the position information is linked to the models by means of the identification code in the planning program.

What is claimed is:

1. A model assembly of a production plant composed of a planar base and a multiplicity of real, two-dimensional or three-dimensional models of production devices, said models being located on said base and being true-to-scale at least in terms of their area requirement on the base, and the models being provided with machine-readable carriers of identification codes, wherein the carriers have, in addition to the identification codes, position codes which contain coordinates of the respective position of the carriers on the models.

2. The model assembly according to claim 1, wherein the carriers can be read out optically and are accessible optically from a viewing direction from above onto the base.

3. The model assembly according to claim 2, wherein the identification codes are composed of one-dimensional or two-dimensional barcodes.

4. A method for inputting a spatial assembly of production devices, which together form a production plant, into a computer-assisted planning program, the method comprising:
generating real, two-dimensional or three-dimensional models, which are true-to-scale at least in terms of their area requirement, of the production plants,
providing the models with machine-readable carriers of identification codes,
in addition to the identification codes, providing position codes on the carriers, which position codes contain the coordinates of the respective position of the carriers on the models or which supplement the data records of the production devices in the planning program with the coordinates of the respective position of the carriers on the models,
forming a model assembly of the production facility on a planar base using the models,
creating at least one digital image of the model assembly with an image sensor from a viewing direction from above onto the base,
registering the identification codes of the models by machine,
calculating the position of the models represented by the carriers on the base by determining the position of the carriers taking into account the position codes of the carriers or the coordinates of the position in the data records of the planning program, and
linking the positions of the models to data records of the production devices in the planning program by means of the identification codes.

5. The method according to claim 4, wherein the carriers can be read out optically and are mounted on the models in such a way that they are optically accessible from a viewing direction from above onto the base after the models have been placed on the base.

6. The method according to claim 5, wherein the digital image is evaluated for the purpose of the machine registration of the optically readable identification code.

7. The method according to claim 4, wherein a plurality of overlapping images of the model assembly are recorded.

8. The method according to claim 7, wherein
the images overlap to such an extent that each carrier is depicted on at least two images, and
faults during the determination of the position of the respective model owing to the perspective distortion in the images are corrected by comparing at least two relevant images.

9. The method according to claim 4, wherein
a chronological sequence of digital images is created of the model assembly using the image sensor,
changes in the positions of the carriers are determined by comparing the images, and
the updated positions of the carriers are linked to data records of the production devices in the planning program by means of the identification codes.

10. The method according to claim 4, wherein with the planning program an output device is actuated, on which the changes in the positions of the production devices which are linked to the carriers are represented.

11. A system for inputting a spatial assembly of production devices, which together form a production plant, into a computer-assisted planning program, comprising:
real, two-dimensional or three-dimensional models, which are true-to-scale at least in terms of their area requirement, of the production plants,
wherein the models comprise machine-readable carriers of identification codes, and position codes on the carriers, which position codes contain the coordinates of the respective position of the carriers on the models or which supplement the data records of the production devices in the planning program with the coordinates of the respective position of the carriers on the models,
means for forming a model assembly of the production facility on a planar base using the models,
means for creating at least one digital image of the model assembly with an image sensor from a viewing direction from above onto the base,
means for registering the identification codes of the models by machine,
means for calculating the position of the models represented by the carriers on the base by determining the position of the carriers taking into account the position codes of the carriers or the coordinates of the position in the data records of the planning program, and
means for linking the positions of the models to data records of the production devices in the planning program by means of the identification codes.

12. The system according to claim 11, wherein the carriers can be read out optically and are mounted on the models in such a way that they are optically accessible from a viewing direction from above onto the base after the models have been placed on the base.

13. The system according to claim 12, wherein the digital image is evaluated for the purpose of the machine registration of the optically readable identification code.

14. The system according to claim 11, wherein a plurality of overlapping images of the model assembly are recorded.

15. The system according to claim 14, wherein
the images overlap to such an extent that each carrier is depicted on at least two images, and
faults during the determination of the position of the respective model owing to the perspective distortion in the images are corrected by comparing at least two relevant images.

16. The system according to claim 11, wherein
a chronological sequence of digital images is created of the model assembly using the image sensor,
changes in the positions of the carriers are determined by comparing the images, and
the updated positions of the carriers are linked to data records of the production devices in the planning program by means of the identification codes.

17. The system according to claim 11, wherein with the planning program an output device is actuated, on which the changes in the positions of the production devices which are linked to the carriers are represented.
